(19) United States
(12) Patent Application Publication
(10) Pub. No.: US 2013/0122755 A1
(43) Pub. Date: May 16, 2013

(54) Electrical Connector with Wafer Having Inwardly Biasing Dovetail

(71) Applicants: Jason Smith, Sartell, MN (US); Emad Soubh, Camas, WA (US)

(72) Inventors: Jason Smith, Sartell, MN (US); Emad Soubh, Camas, WA (US)

(21) Appl. No.: 13/296,179

(22) Filed: Nov. 14, 2011

(51) Int. Cl. H01R 13/514

(52) U.S. Cl. 439/701

(57) ABSTRACT

An electrical connector comprises a plurality of wafers within a housing. Each wafer comprises a dovetail that corresponds to a dovetail-receiving groove on the interior side wall of the housing. The coupling of the dovetail and the groove work to stabilize the housing by biasing the side wall inwardly and preventing it from bowing out. Each wafer also comprises an epoxy shoulder to create an epoxy track that can be filled with epoxy to create a seal that secures adjacent wafers to each other and also prevents debris and moisture from entering the housing.

### BACKGROUND OF THE INVENTION

1. Field of Invention

The present invention is directed to an electrical connector with a wafer having a dovetail that inwardly biases the sidewalls of the connector.

2. Description of Related Art

Traditional electrical connectors with wafers having dovetail features are designed as coupling mechanisms to secure dovetails together or to provide spacing between wafers. Other connectors with either wafers or grooves are discussed in U.S. Pat. No. 5,495,194; U.S. Pat. No. 6,558,202; U.S. Pat. No. 7,422,490; and U.S. Patent Application Publication 2009/011655.

### SUMMARY

The present invention is an electrical connector with a housing having sidewalls. A plurality of wafers with a dovetail on each end are disposed between the sidewalls. The dovetails correspond and connect to a dovetail-receiving groove on the interior of each side wall of the housing. The coupling of the dovetail with this groove biases the side wall inwardly to prevent the housing side walls from bowing out.

Each wafer may also include an epoxy shoulder that forms an epoxy track when adjacent to a like wafer. A bead of epoxy can be introduced into an epoxy track formed between adjacent wafers. The bead then creates a seal that secures the wafers to each other. Additionally, the epoxy seal prevents debris and moisture from entering the housing.

### BRIEF DESCRIPTION OF THE DRAWINGS

The apparatus of the invention is further described and explained in relation to the following figures of the drawing wherein:

FIG. 1 is a top perspective view of a housing containing a plurality of wafers having dovetails and female electrical contacts with one wafer removed from the housing;

FIG. 2 is a top perspective view of a wafer having dovetails and female electrical contacts;

FIG. 3 is a cross-section view of a dovetail;

FIG. 4 is a cross-section view of a dovetail disposed within a dovetail-receiving groove;

FIG. 5 is a top perspective view of a housing containing a plurality of wafers having dovetails with five wafers removed from the housing; and

FIG. 6 is a side elevation view of three adjacent wafers with epoxy tracks formed between two immediately adjacent wafers.

### DETAILED DESCRIPTION OF THE PREFERRED EMBODIMENTS

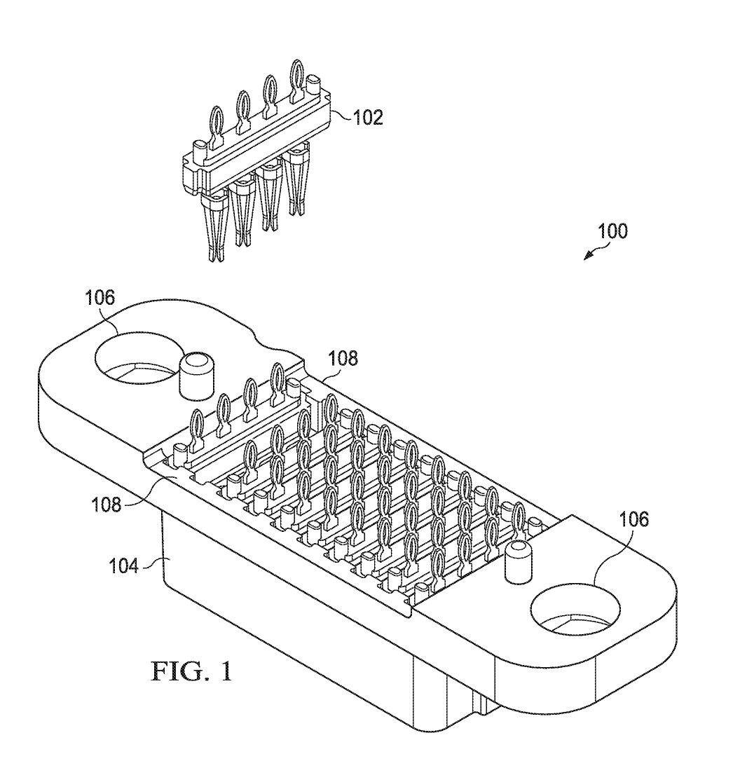

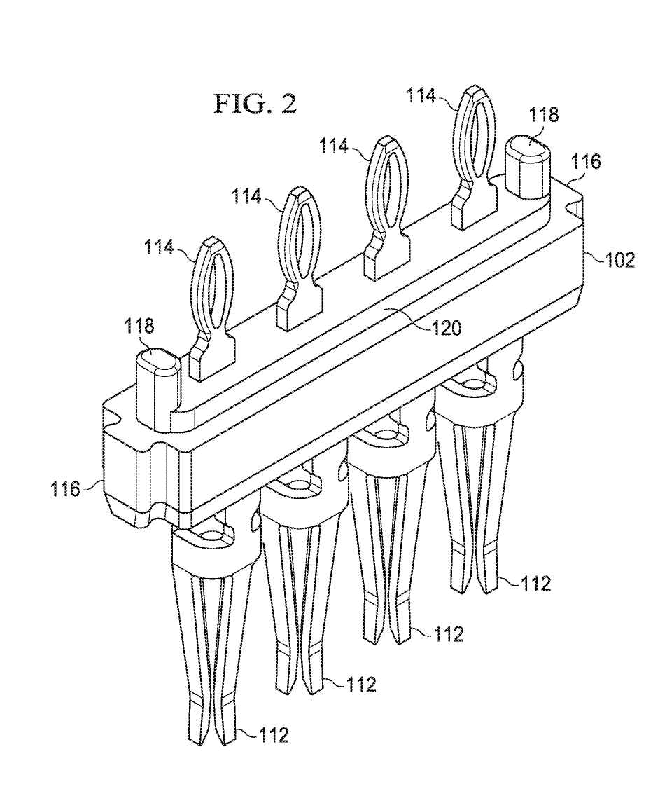

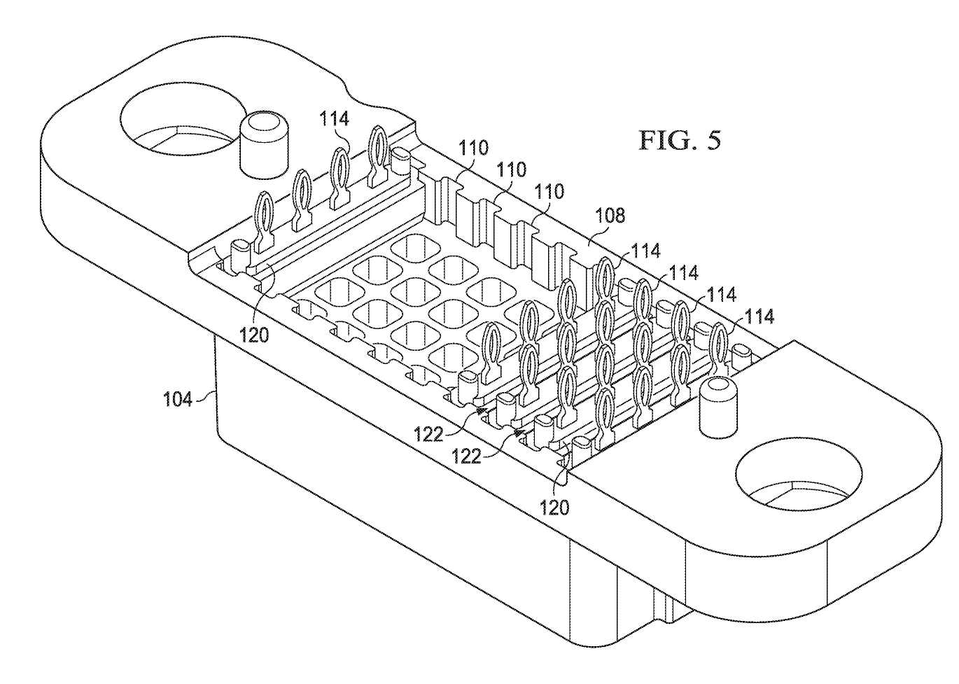

As shown in FIGS. 1 and 5-7, connector 100 comprises a plurality of wafers 102 and a housing 104. Connector 100 can be either a male or female connector, and wafers 102 can be either pin or socket wafers. If connector 100 is a male connector, wafers 102 are pin wafers. As shown in FIGS. 1 and 2, if connector 100 is a female connector, wafers 102 are socket wafers. As shown in FIG. 2, a wafer 102 features a dovetail 116 on each end, epoxy shoulder 120, a plurality of electrical contacts 112, and a plurality of terminals 114. The number of electrical contacts 112 is equal to the number of terminals 114, which can be either attachment terminals or attachment tabs. A plurality of wafers 102 is disposed within housing 104, which comprises two housing side walls 108. As shown in FIG. 5, each housing side wall 108 comprises a plurality of dovetail-receiving grooves 110 where the number of dovetail-receiving grooves on one housing side wall 108 allows receipt of the same number of wafers 102 disposed within housing 104. Wafer 102 can be detachably coupled to housing 104.

When wafer 102 is placed in housing 104, dovetail 116 slides vertically into place in dovetail-receiving groove 110. The connection of dovetail 116 to dovetail-receiving groove 110 works to stabilize housing 104 by biasing housing side wall 108 inwardly. Pulling housing side wall 108 inwardly in this manner reduces or prevents it from bowing out or shifting. This type of support in turn stabilizes housing 104. The inwardly-biased stabilization afford the ability to reduce the thickness of the housing sidewalls 108. Wafers 102 can also optionally feature a stand-off 118, as shown in FIG. 2, which can help bear the force of the contact mating, thereby reducing stress on joints. Stand-off 118 projects above a top surface of the side wall 108 and can be generally rectangular.

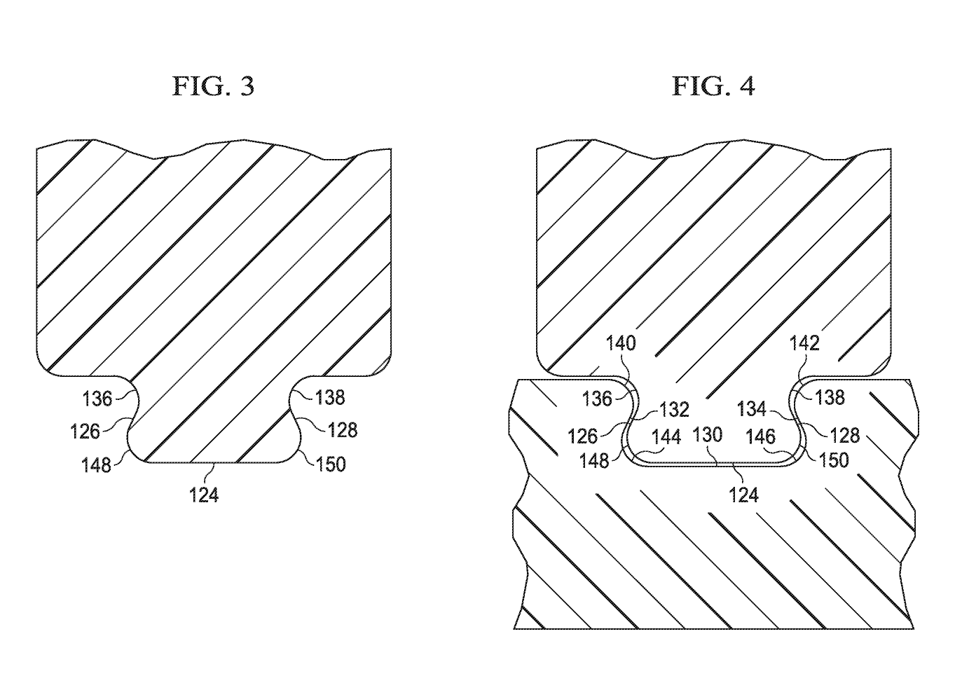

As shown in FIG. 2, dovetail 116 can be on both a first end and a second end of a wafer 102. As shown in FIGS. 3 and 4, dovetail 106 comprises a leading face 124, a first side face 126, and a second side face 128. As shown in FIG. 4, each dovetail-receiving groove 110 comprises a front face 130, a first surrounding face 132, and a second surrounding face 134. As each dovetail 116 vertically slides into a corresponding dovetail-receiving groove 110, its leading face 124 frictionally engages with front face 130, first side face 126 frictionally engages with first surrounding face 132, and second side face 128 frictionally engages with second surrounding face 134. Each face of dovetail 116 is preferably parallel with the corresponding face of dovetail-receiving groove 110. In one embodiment, leading face 124 optionally features a chamfer or slant towards its lower edge, which helps facilitate the insertion of dovetail 116 into dovetail-receiving groove 110.

As shown in FIG. 3, a first wafer corner radius 136 is defined at the intersection of the body of the wafer and first side face 126, and a second wafer corner radius 138 is defined at the intersection of the body of the wafer and second side face 128. A first dovetail radius 148 is defined at the intersection of first side face 126 and leading face 124, and a second dovetail radius 150 is defined at the intersection of second side face 128 and leading face 124. As shown in FIG. 4, first housing corner radius 140 corresponds to first wafer corner radius 136 and is defined at the intersection of the interior of housing side wall 108 and first surrounding face 132 of dovetail-receiving groove 110. Likewise, a second housing corner radius 142 corresponds to second wafer corner radius 138 and is defined at the intersection of the interior of housing side wall 108 and second surrounding face 134 of dovetail-receiving groove 110. Additionally, a first groove corner radius 144 corresponds to first dovetail corner radius 148 and is defined at the intersection of first surrounding face 132 and front face 130. A second groove corner radius 146 corresponds to second dovetail corner radius 150 and is defined at the intersection of second surrounding face 134 and front face 130.

In one embodiment the total included angle between first side face 126 and second side face 128 is greater than or equal to 60 degrees and preferably greater than or equal to 90 degrees. The angle between leading face 124 and either side face is less than or equal to 45 degrees. The angles of the faces of dovetail-receiving groove 110 correspond to the angles of dovetail 116. In one embodiment having a chamfer or slant at the bottom edge of leading face 124, the angle of the chamfer or slant is less than or equal to 45 degrees.

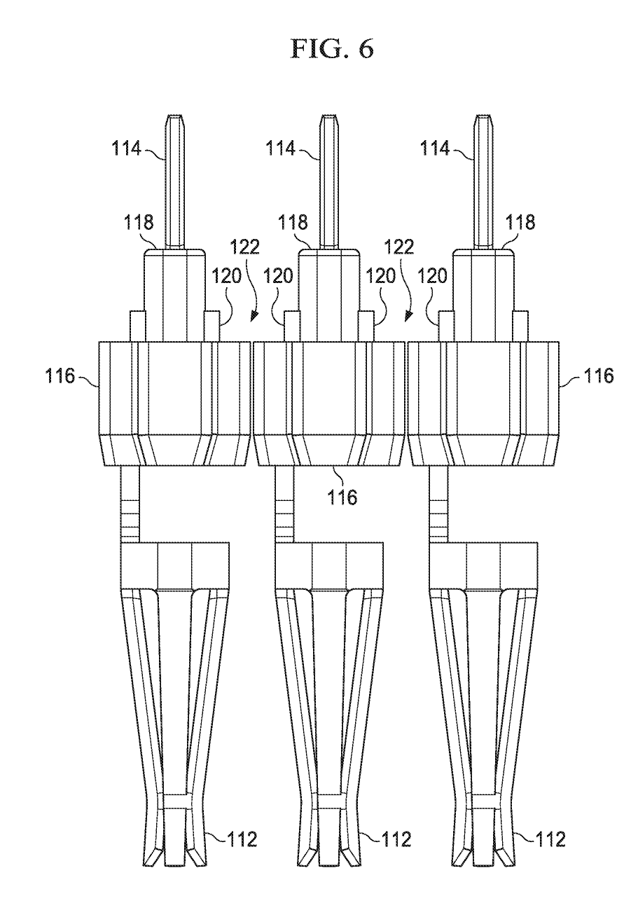

As shown in FIGS. 5 and 6, epoxy shoulders 120 of adjacent wafers 102 when aligned create an epoxy track 122 that is designed to receive a bead of epoxy between each wafer 102. The epoxy creates a seal to secure each wafer 102 to one or more adjacent wafers 102. The epoxy seal also works to prevent debris or moisture from entering housing 104. Some other methods of construction apply a coating on the entire connector after all wafers have been placed within a housing. Other methods use a gasket or seal between mating connectors. In contrast, in the present invention, the bead of epoxy is introduced into epoxy track 122 as each wafer 102 is being placed into housing 104.

1. An electrical connector comprising:
a housing having a first side wall, a second side wall, at least one dovetail-receiving groove on the inside of the first side wall, and at least one dovetail-receiving groove on the inside of the second side wall;
at least one wafer comprising a first end, a second end, a first dovetail on the first end, a second dovetail on the second end, and at least one electrical contact; and
wherein said first dovetail of said first end of said wafer is detachably received into a first dovetail-receiving groove of said housing and said second dovetail of said second end of said wafer is detachably received into said second dovetail-receiving groove of said housing and inwardly bias the side walls of the connector.

2. The electrical connector of claim 1 wherein the at least one wafer further comprises a shoulder.

3. The electrical connector of claim 2 wherein at least a second wafer includes a shoulder and the shoulders of adjacent wafers create an epoxy track that is able to receive a bead of epoxy.

4. The electrical connector of claim 1 wherein said at least one wafer further comprises a stand-off that can bear some of the force of contact mating.

5. The electrical connector of claim 1 wherein each dovetail contains a plurality of corner radii.

6. The electrical connector of claim 1 wherein each dovetail-receiving groove contains a plurality of corner radii.

7. The electrical connector of claim 1 further comprising a plurality of wafers.

8. The electrical connector of claim 1 wherein said wafer comprises a plurality of electrical contacts.

9. The electrical connector of claim 1 wherein said wafer comprises four electrical contacts.

10. The electrical connector of claim 1 wherein said wafer further comprises a first stand-off and a second stand-off.

11. The electrical connector of claim 1 wherein the electrical connector is a female connector.

12. The electrical connector of claim 1 wherein the electrical connector is a male connector.
